(19) United States
(12) Patent Application Publication
(10) Pub. No.: US 2006/0156792 A1
(43) Pub. Date: Jul. 20, 2006

(54) Multi-dimensional liquid chromatography separation system and method

(76) Inventor: Yongdong Wang, Wilton, CT (US)

Correspondence Address: David Aker, 23 Southern Road, Hartsdale, NY, 10530, US

(21) Appl. No.: 11/249,722

(22) Filed: Oct. 12, 2005

Related U.S. Application Data
(60) Provisional application No. 60/618,199, filed on Oct. 12, 2004.

(51) Int. Cl. G01N 30/02; G01N 30/90

(52) U.S. Cl. 73/23.37

(57) ABSTRACT

A multi-dimensional separation system having parallel traps for effluent from prior separation dimension and parallel latter separation columns, the latter columns being coupled to the traps. At least one trap enriches components of effluent while at least one other trap is releasing trapped components to a detector, which may be a mass spectrometer. Internal standards may be provided, as in a release solvent, for the calibration of one of the chromatographic columns and the detection system. The system may comprise a multiple channel selector for multiple streams, wherein all of the streams flow at the same time.

This application claims priority, under 35 U.S.C. §119(e), from provisional patent application Ser. No. 60/618,199 filed on Oct. 12, 2004, which is hereby incorporated by reference in its entirety.

### BACKGROUND OF THE INVENTION

1. Field of the Invention

The present invention relates to multi-dimensional liquid chromatography separation systems and methods. More particularly, it relates to those apparatus and methods that may be used to separate complex mixtures of molecules.

2. Prior Art

In a typical two-dimensional liquid chromatography system, the separation of the second dimension is carried out one fraction from the first dimension at a time, in a serial fashion. Although relatively simple to implement, this strategy limits the overall efficiency of the separation system. Even though the intrinsic separation speeds of the two dimensions are comparable, the first dimension separation has to slow down so that the next fraction of the first dimension is produced just when the second dimension separation for the current fraction is done. The number of fractions from the first dimension is often limited to a small number, due to the total time required to separate these fractions by the second dimension. It is thus desirable to have a second dimension separation throughput much higher than the first dimension, but the throughput, even after being optimized for speed, is still quite limited due to this serial separation process.

### SUMMARY OF THE INVENTION

It is an object of this invention to provide a parallel separation apparatus and process where the total separation time is roughly the sum of that for each dimension rather than the product of respective dimensions.

It is another object of the invention to provide apparatus and methods having an advantage of at least five times the throughput speed for 2D separation, with the advantage becoming much more significant as one moves to higher and higher dimensions.

It is another object of the invention to achieve the improvement in separation speed without the use of too many parallel separation columns in latter dimensions, thus allowing for many more fractions from earlier dimensions to be further separated in latter dimensions cost-effectively.

It is another object of the invention to provide an easy means to add internal standards so that each latter column can be individually calibrated while online along with the detection system.

It is yet another object of the invention to provide a means to concentrate separated components prior to the detection and thus gain in detection sensitivity.

Compared to one-dimensional separation, detection mechanisms with higher sensitivity are desired, because the components being detected are spread over a two-dimensional plane instead of a one-dimensional line.

These objects and others are achieved in accordance with the invention by the use of at least two groups of traps where one group undergoes the next dimension of separation while others are continuously collecting fractions. The use of a novel trap and release scheme prior to the detection system allows for component concentrating and flexible management of trap-release-detection timing among traps and groups of traps. The invention also utilizes online introduction of internal standards through the release solvent. All of these features may be provided in a fully automated mode, resulting in an un-attended analytical system where many processes such as separation, sample handling, component concentrating, calibration, and detection are all occurring simultaneously in order to achieve high throughput.

### BRIEF DESCRIPTION OF THE DRAWINGS

The foregoing aspects and other features of the present invention are explained in the following description, taken in connection with the accompanying drawings, wherein:

FIG. 1 is a schematic of a two-dimensional liquid chromatography system, in accordance with the invention.

FIG. 2 is a schematic of a trap-and-release for detection portion of the system of FIG. 1.

FIG. 3 is a schematic of a two-dimensional liquid chromatography system, in accordance with an alternative implementation of the invention.

FIG. 4 is a schematic of a two-dimensional liquid chromatography system with four parallel channels for the second dimension.

FIG. 5 is an alternative implementation using trap and release for automated online detection, in the system of FIG. 3.

FIG. 6 illustrates an apparatus for flow switching with desired characteristics suitable for use with the invention, in a first, selected position.

FIG. 7 illustrates the apparatus of FIG. 6 in a second, selected position.

FIG. 8 illustrates another apparatus for flow switching with desired characteristics suitable for use with the invention, in a first, selected position.

FIG. 9 illustrates the apparatus of FIG. 8 in a second, selected position.

FIG. 10 is a partially schematic, partially perspective view of a parallel fraction collection system with multiple collection wells for collecting eluted fractions from an array of multidimensional columns.

FIG. 11 is a block diagram of an analysis system in accordance with the invention, including a mass spectrometer as the detector.

### DETAILED DESCRIPTION OF THE PREFERRED EMBODIMENT

The invention, an improved multi-dimensional liquid chromatography system, has multiple fraction traps to collect fractions from the first dimension. The traps are coupled with an array of second dimensional separation columns. These traps are divided into multiple groups, each group containing the same number of traps as the number of second dimensional separation columns. While one group of traps is in the process of collecting fractions, the other groups undergo the other processes, including the second dimensional separation. Fractions collected in a group of traps are separated by the second dimensional columns simultaneously in a parallel fashion. The processes undergone by the groups rotate until the whole separation task is completed. Because the second dimensional separation is now carried out in parallel, much higher overall separation efficiency can be achieved.

For simplicity and clarity, integrated and on-line two-dimensional systems are first used as examples in the following discussion. Then the ideas/concepts/designs are applied/expanded/extended to systems with a greater number of dimensions.

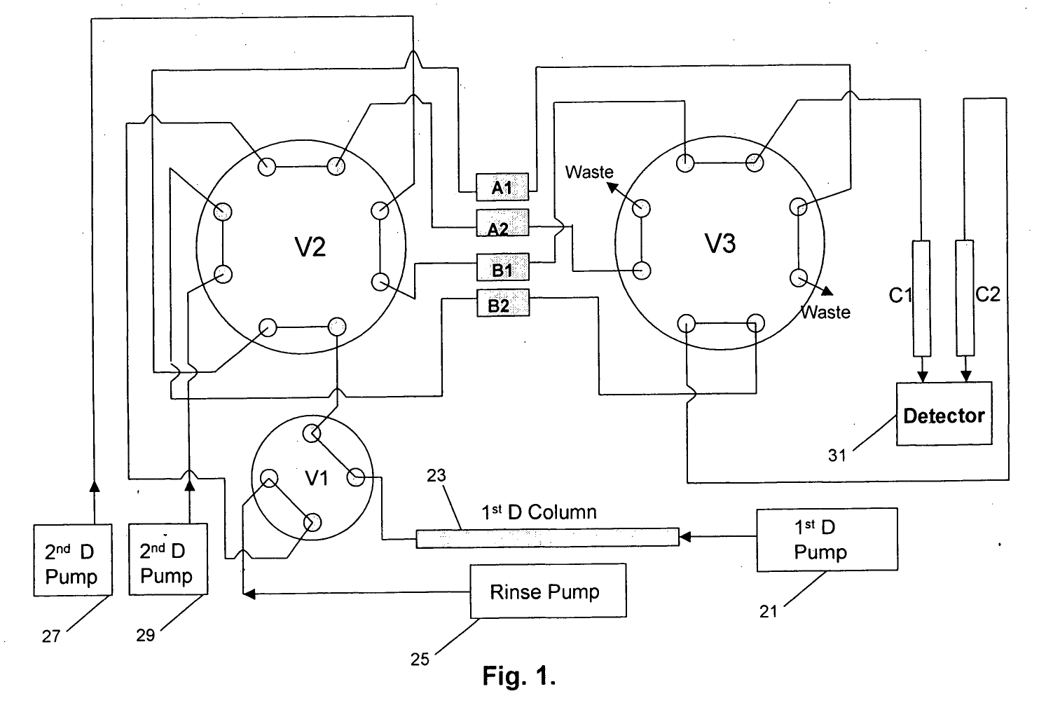

FIG. 1. is a schematic of a two-dimensional liquid chromatography system. A first dimension pump 21 feeds effluent from a source, such as a sample preparation apparatus (not shown) to a first dimension column 23. A1 and A2 form one group of traps (Group A), and B1 and B2 form the other group (Group B). When the valves V1, V2, and V3 are in the states shown in the figure, trap A1 is trapping effluent from the first dimension column 23, and trap A2 is rinsed by the flow from the rinse pump 25. At the same time, the mobile phase from second dimension pump(s) 27 and 29 is directed to trap B1 and B2, passing through the second dimension separation columns C1 and C2 respectively, to the detector 30. When V1 changes its state, trap A1 will be rinsed and trap A2 will trap the first dimension effluent. When V1 and V2 change state simultaneously, processes experienced by Group A and B traps will be switched, i.e., reversed.

The detector 31 can be a multi-channel detector capable of monitoring effluent from C1 and C2 simultaneously. A1ternatively, separate detectors can be used for C1 and C2.

The styles of traps include a segment of simple hollow tube, packed or open-tubular chromatography columns or solid phase extraction columns.

The rinse pump 25 is optional. The functions of the rinse pump 25 include pushing remaining effluent into the traps, and rinsing the traps before the second dimensional separation.

C1 and C2 can be integrated with the traps and thus can be optional as separate units.

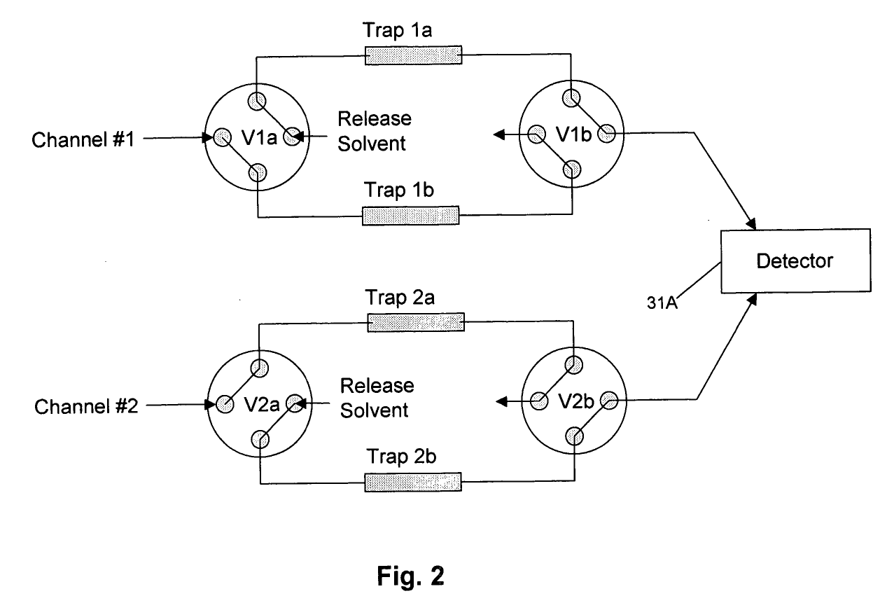

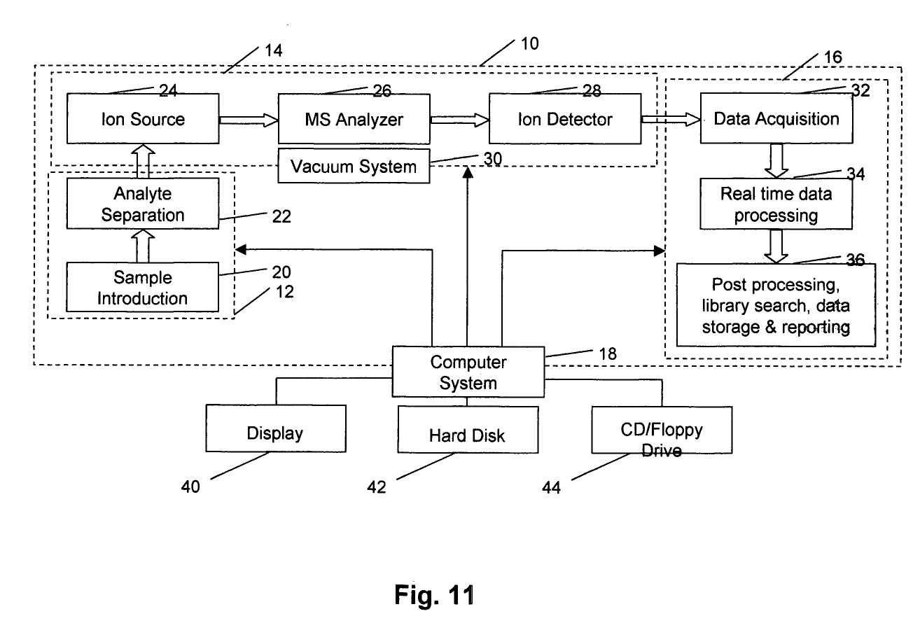

FIG. 2 is a schematic of a trap-and-release for detection. Trap 1b and 2a are trapping effluents from channel #1 and #2, respectively. Trap 1a and 2b are subjected to the release solvent, which strips the trapped compounds for detection. The valves V1a and V1b switch simultaneously at certain time intervals, as do valve V2a and V2b. As a result of the trap-and-release process, the components reach the detector 31A in enriched and compressed zones, and thus higher detection sensitivity is possible. In addition, internal standards can be added into the release solvent for the calibration of each chromatographic column as well as the detector, which may be, for example, a mass spectrometer, as more fully described below with respect to FIG. 11.

The styles of traps can include packed or open-tubular chromatography or solid phase extraction columns. Other chemical, electrochemical, or physical mechanisms that can lead to desired trap-and-release processes can also be used with trap-and-release detection.

The traps should be installed as close to the detector as possible to minimize zone broadening.

The trap-and-release detection scheme is particularly suitable for multiplexing detectors which scan all the channels but actually only spend a fraction of the total detection time on each individual channel, such as the Micromass (now Waters) mass spectrometers equipped with MUX interface. With proper control, trapped components can be released at such an optimal time that, while one channel is scanned, the enriched zone for this channel reaches the detector, but the enriched zones from the other channels are queued closely behind. Consequently, not only are most of the components enriched and subjected to detection, but also the components of one channel are detected with minimized interference from the other channels, or with minimized cross-talk.

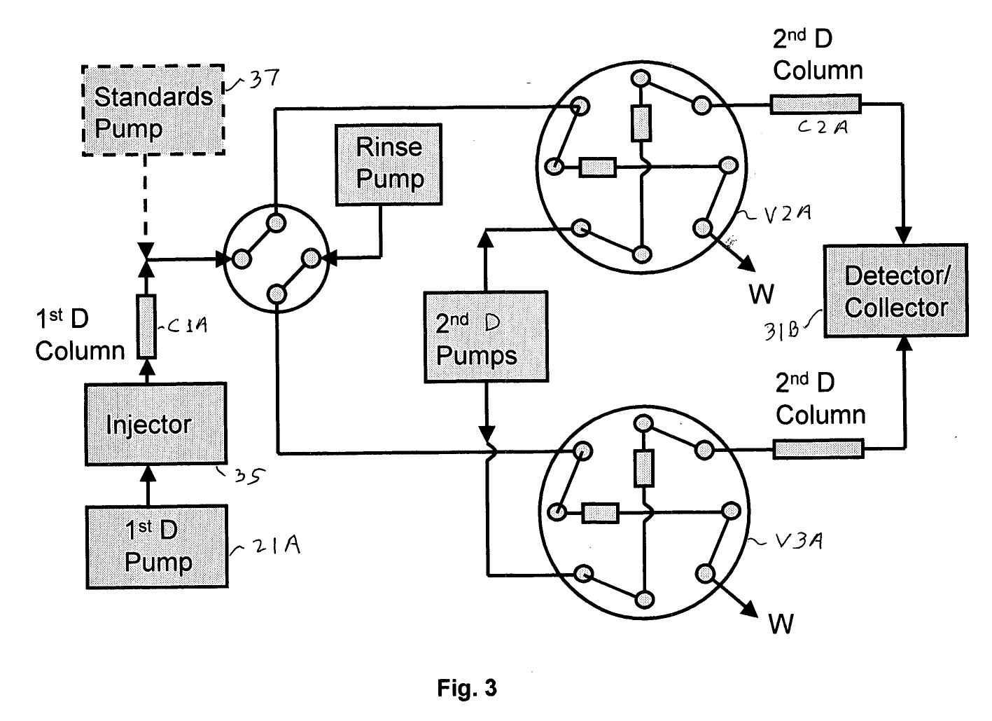

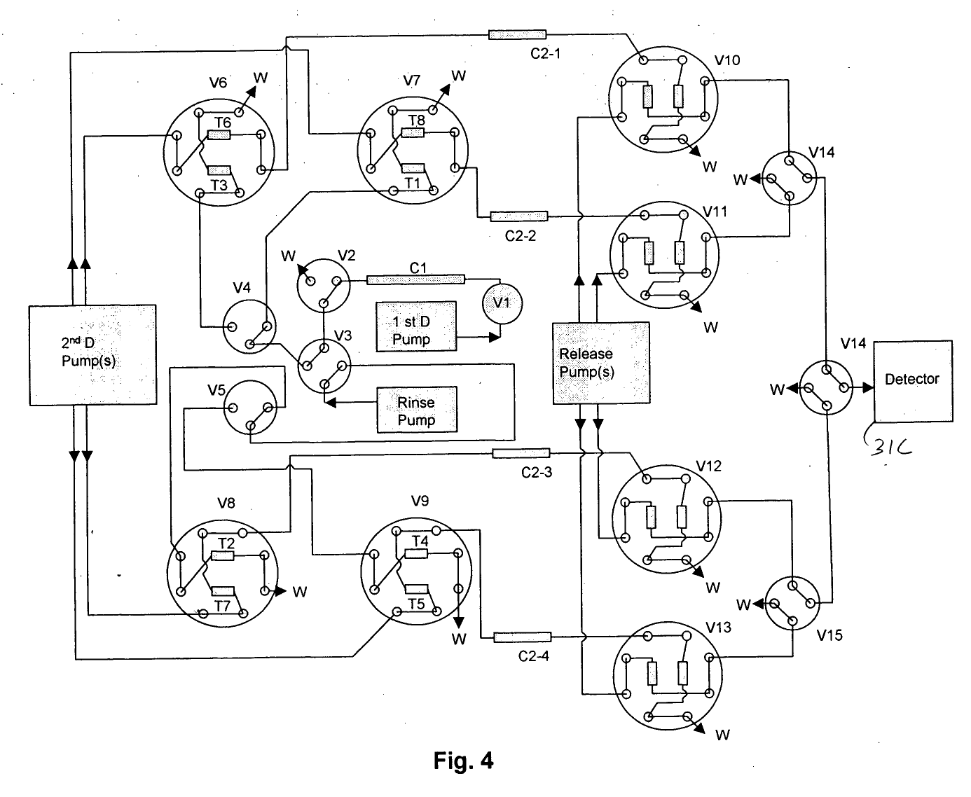

FIG. 3 and FIG. 4 illustrate other possible designs of two-dimensional liquid chromatography systems.

In FIG. 3, a first dimension pump 21A feeds an injector 35 to a first dimension column C1. A rinse pump 25A is connected to a valve V1A. A Standards pump 37 provides a calibration standard to V1A. A second dimension pump 39 feeds V2A and V3A. The sample streams from second dimension chromatography columns C2A and C2B are received by a detector/collector 31B.

FIG. 4 scales the invention to a four column arrangement.

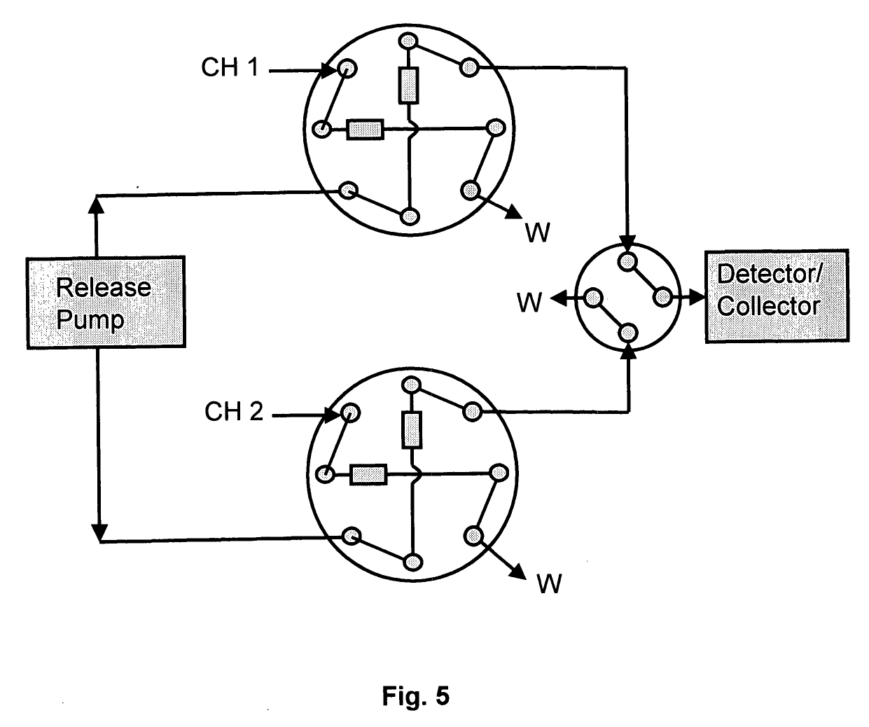

FIG. 5 illustrates another trap-and-release design, for use in place of that from FIG. 2 and can be incorporated into FIG. 1, FIG. 3, or FIG. 4.

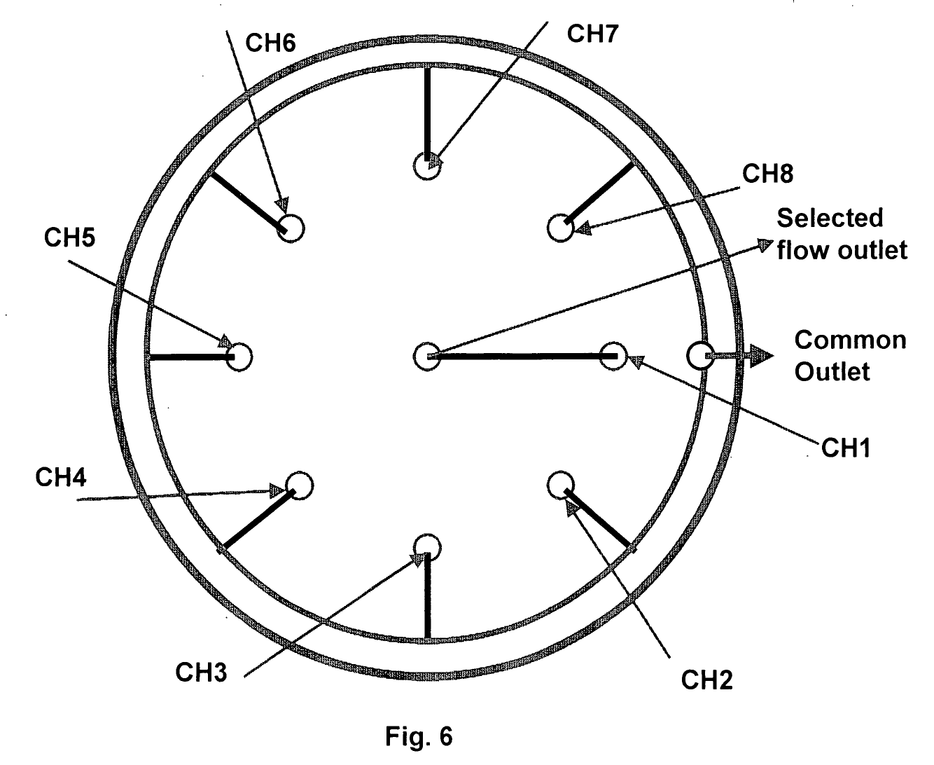

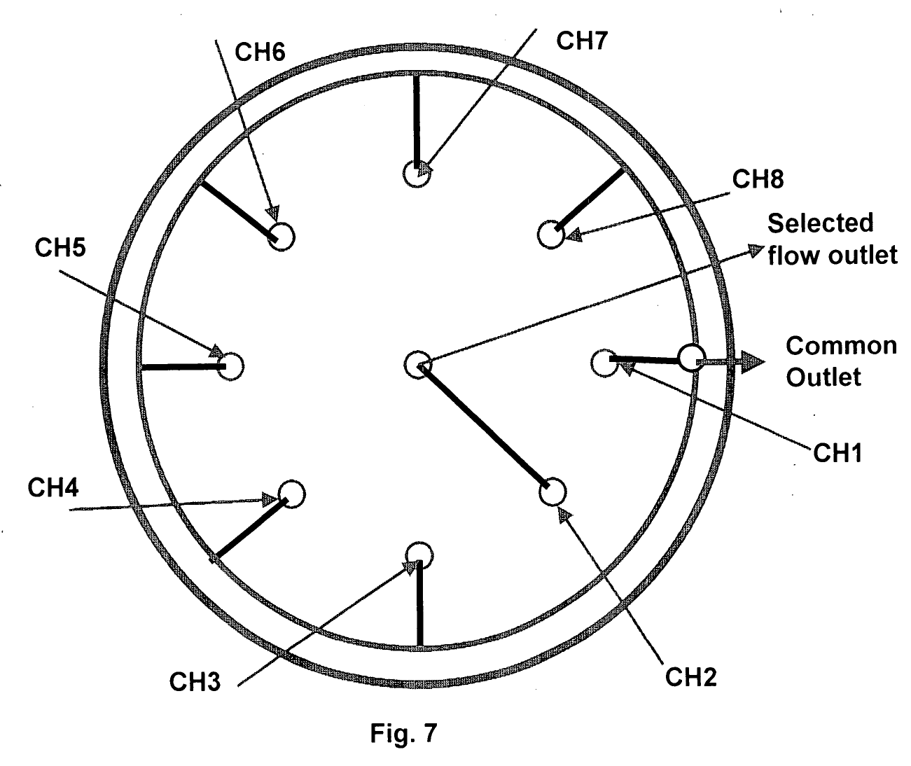

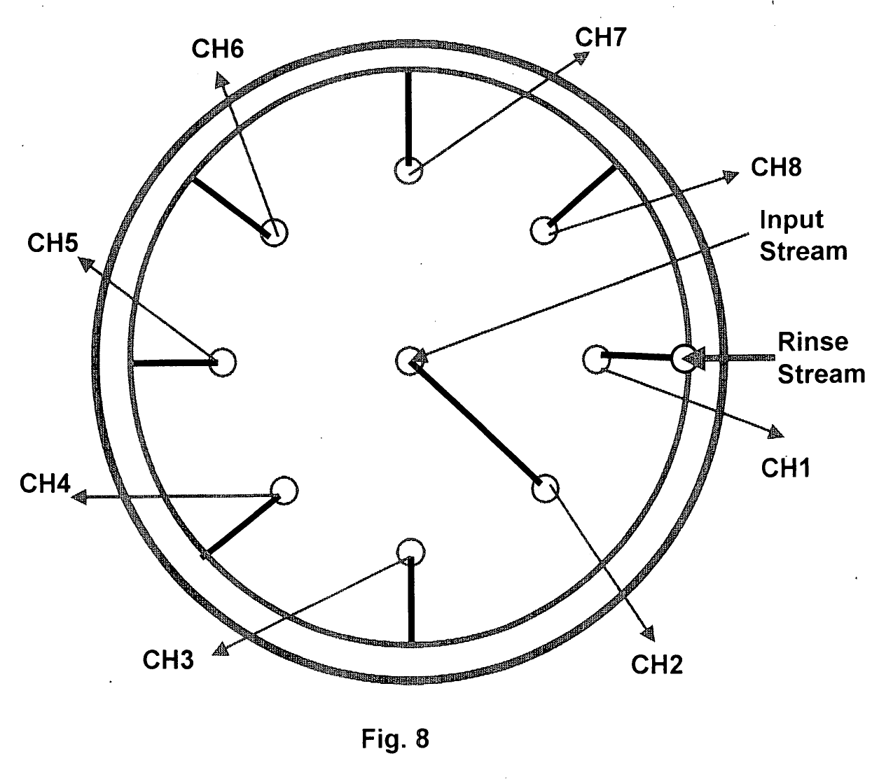

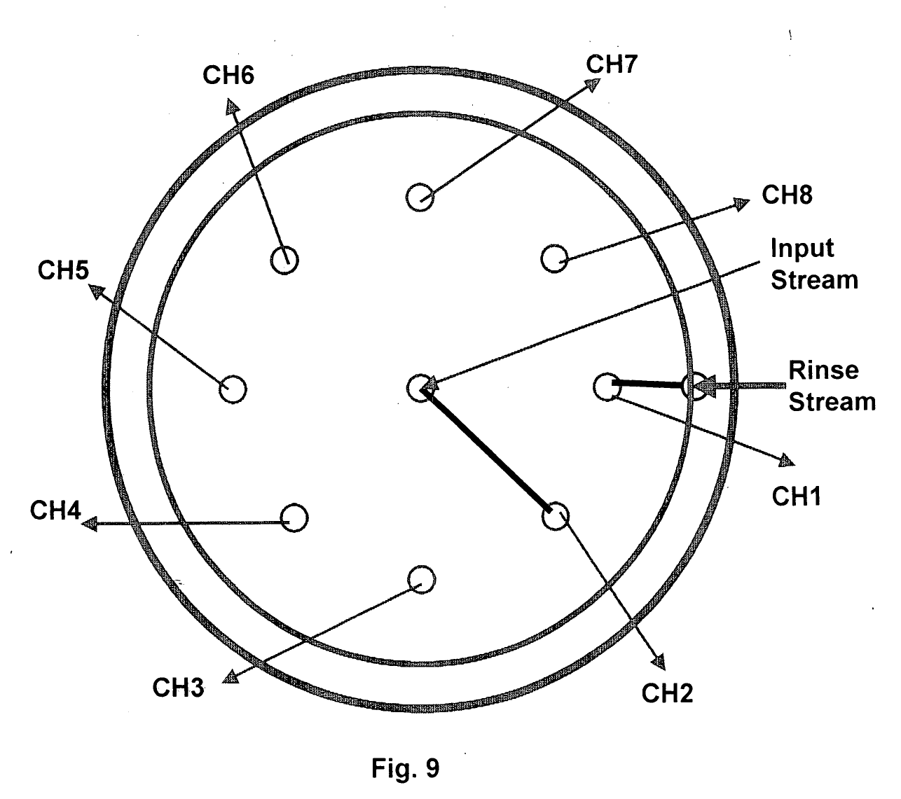

Flow switching devices with low dead volume, minimum cross talk between channels, ability to handle large number of channels are critical in multidimensional liquid chromatography systems. Two designs with such characteristics are shown, with a first in FIG. 6 and FIG. 7, and a second in FIG. 8 and FIG. 9.

FIG. 6 illustrates a rotary valve for N-to-1 flow switching. All of the circles (both large and small), which are represented by a lighter shade of black (or gray) are stationary, the darker black portion is rotated to select one of the many input channels. All the streams of the unselected channels merge and flow out through the common outlet. All the streams (both the selected and unselected) are flowing all the time. The most current sample will be directed to the outlet as each channel is selected. CH1 is the selected stream at the position show in this. The same interpretation of the gray and black portions applies to FIGS. 7, 8 and 9. In FIG. 7, the rotary valve for N-to-1 flow switching is also illustrated. CH2 is the selected stream at the position show in this figure.

FIG. 8 also illustrates a rotary valve for 1-to-N flow switching. The valve may be and in FIG. 8 is, structurally the same as in FIG. 6 and FIG. 7, but is used in a different way. A single input stream is switched to one of the multiple outputs. All the unselected channels are flushed with a rinse stream from a common inlet port. Without the rinse stream, the fluid segment (ending at the valve) of each of the unselected channels will be trapped and later joined with fresh input stream when the channel is selected again, resulting in cross-contamination or cross-talk. The input stream is switched to CH2 in this figure.

FIG. 9 also illustrates a rotary valve for 1-to-N flow switching. A single input stream is switched to one of the multiple outputs. The last selected channel is flushed with a rinse stream from a common inlet port. Without the rinse stream, the fluid segment (ending at the valve) of the unselected channel will be trapped and later joined with fresh input stream when the channel is selected again, resulting in cross-contamination or cross-talk. The input stream is switched to CH2 in this figure. CH1 is the last selected stream and is now being flushed by the rinse stream.

Parallel fraction collection can be a very useful in multidimensional liquid chromatography systems for coupling one dimension to the next dimension, parking fractions for further and/or future treatment and analysis.

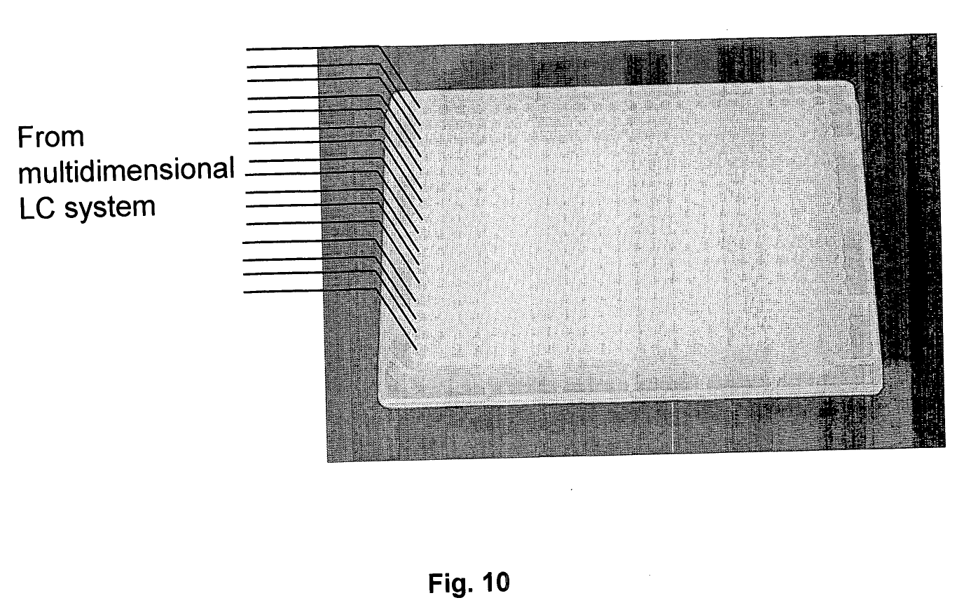

FIG. 10 shows the schematic of parallel fraction collection. In order to collect all the eluents from liquid chromatography columns, one can use tubings with expandable inner diameters under pressure for part of the fraction collection manifold. Thus, the eluents can be temporally stored in the tubings when the flows to the collection probes are stopped during the short period of transition from one set of fractions to the next. This parallel fraction collection combined with a fully automated multidimensional separation system utilizing trap-and-release allows for massive parallelism in high dimensions, for example, 24, 48, 96, or even a higher number of parallel separation columns. When the number of parallel columns exceeds 2 or 4 or 8, the trap-and-release described in FIG. 2 or FIG. 5 for sharing the same detector (typically a mass spectrometer) becomes not practical due to the required high switching frequency.

The use of parallel fraction collection device, however, allows for these fractions to be analyzed offline later on any mass spectrometer, for example, a mass spectrometer fitted with NanoMate ESI chip made by Advion Biosciences (Ithaca, N.Y.) where each fraction can be mass analyzed through direct introduction into a mass spectrometer without further separation.

Referring to FIG. 11 (which corresponds to FIG. 1 of International Patent Application Nos. PCT/US2004/013096 and PCT/US2004/013097, published as WO2004/097581 and WO2004/097582, respectively, which are incorporated herein by reference in their entireties) there is shown a block diagram of an analysis system 10, that may be used to analyze proteins or other molecules, as noted above, incorporating features of the present invention.

Analysis system 10 has a sample preparation portion 12, a mass spectrometer portion 14, a data analysis system 16, and a computer system 18. The sample preparation portion 12 may include a sample introduction unit 20, of the type that introduces a sample containing molecules of interest to system 10, such as Finnegan LCQ Deca XP Max, manufactured by Thermo Electron Corporation of Waltham, Mass., USA. The sample preparation portion 12 may also include an analyte separation unit 22, which is used to perform a preliminary separation of analytes, such as the proteins to be analyzed by system 10. Analyte separation unit 22 may contain any of the multidimensional chromatographic separation arrangements of FIGS. 1 to 10.

The mass separation portion 14 may be a conventional mass spectrometer and may be any one available, but is preferably one of MAIDI-TOF, quadrupole MS, ion trap MS, or FTICR-MS, or some combinations such as a qTOF or triple-stage quadrupole (TSQ). If it has a MALDI or electrospray ionization ion source, such ion source may also provide for sample input to the mass spectrometer portion 14. In general, mass spectrometer portion 14 may include an ion source 24, a mass spectrum analyzer 26 for separating ions generated by ion source 24 by mass to charge ratio (or simply called mass), an ion detector portion 28 for detecting the ions from mass spectrum analyzer 26, and a vacuum system 30 for maintaining a sufficient vacuum for mass spectrometer portion 14 to operate efficiently. If mass spectrometer portion 14 is an ion mobility spectrometer, generally no vacuum system is needed.

The data analysis system 16 includes a data acquisition portion 32, which may include one or a series of analog to digital converters (not shown) for converting signals from ion detector portion 28 into digital data. This digital data is provided to a real time data processing portion 34, which process the digital data through operations such as summing and/or averaging. A post processing portion 36 may be used to do additional processing of the data from real time data processing portion 34, including library searches, data storage and data reporting.

Computer system 18 provides control of sample preparation portion 12, mass spectrometer portion 14, and data analysis system 16, in the manner described below. Computer system 18 may have a conventional computer monitor 40 to allow for the entry of data on appropriate screen displays, and for the display of the results of the analyses performed. Computer system 18 may be based on any appropriate personal computer, operating for example with a Windows® or UNIX® operating system, or any other appropriate operating system. Computer system 18 will typically have a hard drive 42, on which the operating system and the program for performing the data analysis described below is stored. A drive 44 for accepting a CD or floppy disk is used to load the program in accordance with the invention on to computer system 18. The program for controlling sample preparation portion 12 and mass spectrometer portion 14 will typically be downloaded as firmware for these portions of system 10. Data analysis system 16 may be a program written to implement the processing steps discussed below, in any of several programming languages such as C++, JAVA or Visual Basic.

Although the description above contains many specifics, these should not be construed as limiting the scope of the invention but as merely providing illustrations of some feasible embodiments of this invention. For example, there may be more than two groups with each group including more than two traps, requiring the valves to operate in a multi-state mode instead of a binary mode.

Thus the scope of the invention should be determined by the appended claims and their legal equivalents, rather than by the examples given. Although the present invention has been described with reference to the single embodiment shown in the drawings, it should be understood that the present invention can be embodied in many alternate forms of embodiments. In addition, any suitable size, shape or type of elements or materials could be used.

What is claimed is:

1. A multi-dimensional separation system having parallel traps for effluent from prior separation dimension and parallel latter separation columns, said latter columns being coupled to said traps.

2. The system of claim 1, in combination with a detector for receiving output of said system.

3. The combination of claim 12, wherein said detector comprises a mass spectrometer.

4. A method of improving detection of effluent, comprising providing at least one trap to enrich components of effluent while at least one other trap is releasing trapped components to a detector.

5. The method of claim 4, further comprising including internal standards in a release solvent for the calibration of one of the chromatographic columns and detection system.

6. The method of claim 4, wherein said traps are grouped and controlled so that the timing of the release of said components from said groups is optimized for one of maximum sensitivity, minimum cross-talk between said groups, and overall sample throughput.

7. The method of claim 4, further comprising analyzing said enriched components of effluent with a detector.

8. The method of claim 7, wherein said detector is a mass spectrometer.

9. A sample preparation system having parallel traps for samples.

10. The system of claim 9, wherein parallel separation columns are coupled to said traps.

11. A sample selection system comprising a multiple channel selector for multiple streams, wherein all of the streams flow at the same time.

12. The sample selection system of claim 11, wherein said multiple channel selector is an N-to-1 flow switch.

13. The sample selection system of claim 11, wherein one of the streams is selected as a sample, and all streams other than the selected stream are merged and discarded.

14. The sample selection system of claim 11, wherein a single input stream is switched to an output, and channels which are not selected are flushed with a rinse stream.

15. The sample selection system of claim 14, wherein the rinse stream originates in a common inlet port.

16. The sample selection system of claim 11, in combination with a detector for receiving output of said system.

17. The combination of claim 16, wherein said detector comprises a mass spectrometer.
